(19) United States
(12) Patent Application Publication
(10) Pub. No.: US 2010/0046421 A1
(43) Pub. Date: Feb. 25, 2010

(54) Multibeam Antenna System

(76) Inventor: David Adams, Chelmsford (GB)

Correspondence Address: BARNES & THORNBURG LLP, P.O. BOX 2786, CHICAGO, IL, 60690-2786, US

(21) Appl. No.: 11/967,428

(22) Filed: Dec. 31, 2007

(51) Int. Cl. H04B 7/185

(52) U.S. Cl. 370/316

(57) ABSTRACT

Embodiments of the invention relate to beamforming antennas such as can be used in space division multiplexing systems. Space division multiplexing can be used to increase data capacity in wireless networks by enabling different base stations to transmit signals within the same frequency band. Each antenna beam can potentially be used to establish a communication link within an area of wireless coverage, and other communication links established on other antenna beams then represent interference to that user. In order to reduce interference, narrow beamwidths are desirable. These are typically achieved by increasing the aperture of the antenna in the azimuth plane, and in arrangements that require finely divided angular sectors, a greater number of antennas will be required to give three hundred and sixty degree coverage. As a result, there is potentially a large increase in the total surface area of antennas which is undesirable, as it leads to increased wind loading of an antenna tower. Embodiments of the invention provide an arrangement in which data are transmitted from a first transmitter to a first receiver using a first antenna beam, and data are transmitted from a second transmitter to a second receiver using a second antenna beam. The first antenna beam is formed by splitting the signal from the first transmitter into two parts with a first phase relationship between the parts, each part being connected to an antenna. A second antenna beam is formed by splitting the signal from the second transmitter into two parts with a second phase relationship between the parts, each part being connected to one of the two antennas. An advantage of embodiments of the invention is that data can be transmitted from different transmitters at the same frequency without interference, while presenting a smaller antenna aperture than is required with conventional systems.

### FIELD OF THE INVENTION

The present invention relates generally to antennas for wireless data communications networks, and more specifically to beamforming antenna systems.

### BACKGROUND OF THE INVENTION

Modem wireless communications systems place great demands on the antennas used to transmit and receive signals, especially at cellular wireless base stations. Antennas are required to produce a carefully tailored radiation pattern with a defined beamwidth in azimuth, so that, for example, the wireless cellular coverage area has a controlled overlap with the coverage area of other antennas.

In addition to a defined azimuth beam, such antennas are also required to produce a precisely defined beam pattern in elevation; in fact the elevation beam is generally required to be narrower than the width of the azimuth beam.

It is conventional to construct such antennas as an array of antenna elements so as to form the required beam patterns. Such arrays require a feed network to split signals for transmission into components with the correct phase relationship to drive the antenna elements; when receiving, the feed network doubles as a combiner. An array consisting of a single vertical column of antenna elements is commonly used at cellular radio base stations with a tri-cellular cell pattern. Similar arrays, but with two or more columns, may be deployed if narrower azimuth beams are required.

In order to enhance the capacity of a cellular wireless system, it is beneficial to implement space division multiplexing; that is to say, a given frequency band is used substantially independently by wireless links which are spatially separated. Angular selection is a widely used method of space division multiplexing. For example, a cellular radio base station may be equipped with three transceivers that can operate in a given frequency band; each may be connected to an antenna system that gives wireless coverage to an angular sector.

FIG. 1 illustrates a conventional tri-cellular deployment. A number of cell sites 1a . . . 1g are deployed to give wireless coverage to a given area. It can be seen that there are three radiation beams roughly equally spaced in azimuth angle at each cell site (for example, in the case of cell site 1a, there are three radiation beams 3a, 3b, 3c). Further capacity increases can be achieved by sub-dividing the azimuth plane more finely in angle, for example to form a hexsectored plane, as shown in FIG. 2 (in the case of cell site 1 a there are six hexsector radiation beams 5a . . . 5f).

A measure of the average carrier to interference ratio within an area of wireless coverage is often used in evaluating the performance of a space division multiplexed system; this is typically estimated by means of computer simulation. The carrier to interference ratio determines the data throughput rate that can be sustained on a given data link; the use of adaptive modulation and coding in modern radio systems enables the data throughput rate to be maximised within the constraints of available carrier to interference ratio.

It will be appreciated that in terms of a space division multiplexed system, each antenna beam can potentially be used to establish a communication link within an area of wireless coverage. If a communication link is established to a user then other communication links established on other antenna beams represent interference to that user. At a given location, each user will receive the antenna beam which is used for communication at a certain carrier power level, and will also receive signals on other beams, which represent interference, at other power levels. An average carrier to interference ratio experienced by users, averaged over time for a number of users in various representative scenarios, is a useful measure in evaluating system performance.

It is not necessary for each communication link to be used by a different user; in systems such as Multiple In Multiple Out (MIMO), multiple communication channels can be optimally combined together at a single terminal so as to increase capacity for that terminal. Therefore, space division multiplexing can be used either to increase data capacity or to allow greater numbers of terminals to operate within a given frequency band or a combination of both.

In order to achieve a narrower beamwidth, it is generally necessary to increase the aperture of the antenna in the azimuth plane, that is to say the antenna becomes wider. In arrangements that require finely divided angular sectors, a greater number of antennas will be required to give three hundred and sixty degree coverage. As a result, there is potentially a large increase in the total surface area of antennas deployed at a cell site in systems that employ space division multiplexing. This increase in surface area is undesirable, as it leads to increased wind loading of an antenna tower, and in addition rental charges for the use of an antenna tower are often related to the surface area of the antennas deployed.

It is possible to deploy electronically steerable antenna arrays to implement space division multiplexing, but this typically involves deploying active electronics at the top of an antenna tower, which can be undesirable in terms of ease of maintenance.

It is an object of the present invention to provide a method and apparatus which addresses these disadvantages.

### SUMMARY OF THE INVENTION

In accordance with a first aspect of the present invention, there is provided a method of transceiving radio signals in a wireless communication system, the method comprising:

generating a first radio signal at a first transmitter;

generating a second radio signal at a second transmitter;

combining the first radio signal with the second radio signal to form a first antenna signal and a second antenna signal, each said first antenna and second antenna signals comprising components of the first radio signal and the second radio signal, wherein the component of the first radio signal in the first antenna signal is in a first phase relationship with the component of the first radio signal in the second antenna signal and wherein the component of the second radio signal in the first antenna signal is in a second phase relationship with the component of the second radio signal in the second antenna signal;

transmitting said first antenna signal from a first antenna and transmitting said second antenna signal from a second antenna; and

receiving the transmitted first antenna signal and the transmitted second antenna signal at respective first and second receivers, wherein the first receiver is located in an area within which the components of the first signal in said first and second antenna signals constructively interfere and the components of said second signal in the first and second antenna signals destructively interfere, and wherein the second receiver is located in an area within which the components of the first signal in said first and second antenna signals destructively interfere and the components of said second signal in the first and second antenna signals constructively interfere, whereby to synchronise receipt of signals transmitted from said first transmitter with receipt of signals transmitted from said first transmitter.

In embodiments of the invention, data are transmitted from the first transmitter to the first receiver using a first antenna beam, and data are transmitted from the second transmitter to the second receiver using a second antenna beam. The first antenna beam is formed by splitting the signal from the first transmitter into two parts with a first phase relationship between the parts, each part being connected to an antenna. A second antenna beam is formed by splitting the signal from the second transmitter into two parts with a second phase relationship between the parts, each part being connected to one of the two antennas.

An advantage of embodiments of the invention is that data can be transmitted from different transmitters at the same frequency without interference. As a result embodiments of the invention are particularly suited to wireless communications systems configured to operate according to space division multiplexing, in which radio resources, in the form of communication links at a given frequency, can be re-used.

Preferably, the first phase relationship is an anti-phase relationship and the second phase relationship is an in-phase relationship, while the spacing between the antennas in the azimuth plane is between 0.4 and 1.7 wavelengths at the operating frequency of the antennas. As a result, the antenna beam patterns provide good coverage of a typical 120 degree sector; each antenna beam is stronger in a given portion of the angular sector, and the portions of the angular sector in which one beam is stronger are roughly in proportion with the portions of the angular sector in which the other beam is stronger. Whilst the range of spacing is preferably within the afore-mentioned range of 0.4-1.7 wavelengths, particularly preferred spacings are between 0.5-0.6 and 1.1-1.2 wavelengths.

According to a further aspect of the invention there is provided a method of transceiving radio signals in a wireless communication system, the method comprising:

generating a first radio signal at a first transmitter;

generating a second radio signal at a second transmitter;

combining the first radio signal with the second radio signal to form a first antenna signal and a second antenna signal, each said first antenna and second antenna signals comprising components of the first radio signal and the second radio signal, wherein the component of the first radio signal in the first antenna signal is in a first phase relationship with the component of the first radio signal in the second antenna signal and wherein the component of the second radio signal in the first antenna signal is in a second phase relationship with the component of the second radio signal in the second antenna signal;

transmitting said first antenna signal from a first antenna and transmitting said second antenna signal from a second antenna;

receiving the transmitted first antenna signal and the transmitted second antenna signal at a receiver; and

selecting, for decoding at the receiver, one of the first or second radio signals in dependence on whether the components of the first radio signal in said first and second antenna signals constructively interfere or the components of the second radio signal in said first and second antenna signals constructively interfere.

Embodiments according to this further aspect of the invention offer a use of the transmitters/combiner/antennas/receiver configuration that is not limited to space division multiplexing, and one that involves selection of only one of the radio signals transmitted from the different transmitters. Preferably the link is selected on the basis of interference characteristics, and thereby provides a means of maximising the antenna gain and directivity utilised in whichever link between the first or second transmitter and the receiver is selected.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram showing a conventional tri-cellular cellular wireless deployment;

FIG. 2 is a schematic diagram showing a conventional hex-sectored cellular wireless deployment;

FIG. 3 is a schematic diagram showing an embodiment of the invention;

FIG. 4 is a schematic diagram showing a beamforming network forming part of the components shown in FIG. 3;

FIG. 5a is a schematic diagram showing a conventional tri-cellular antenna array;

FIG. 5b is a schematic diagram showing a conventional hex-sectored antenna array;

FIG. 5c is a schematic diagram showing an antenna array configured according to an embodiment of the invention;

FIG. 6 is a schematic diagram showing sum and difference radiation patterns for 0.55 λ azimuth spacing of antenna systems according to an embodiment of the invention;

FIG. 7 is a schematic diagram showing sum and difference radiation patterns for 0.85 λ azimuth spacing of antenna systems according to an embodiment of the invention;

FIG. 8 is a schematic diagram showing sum and difference radiation patterns for 1.16 λ azimuth spacing of antenna systems according to an embodiment of the invention;

FIG. 9 is a schematic diagram showing an example of a cellular deployment according to an embodiment of the invention;

FIG. 10 is a schematic diagram showing an antenna array according to a further embodiment of the invention; and

FIG. 11 is a schematic diagram showing a sum and difference radiation patterns for a conventional tri-cellular antenna beam superimposed upon sum and difference radiation patterns according to an embodiment of the invention.

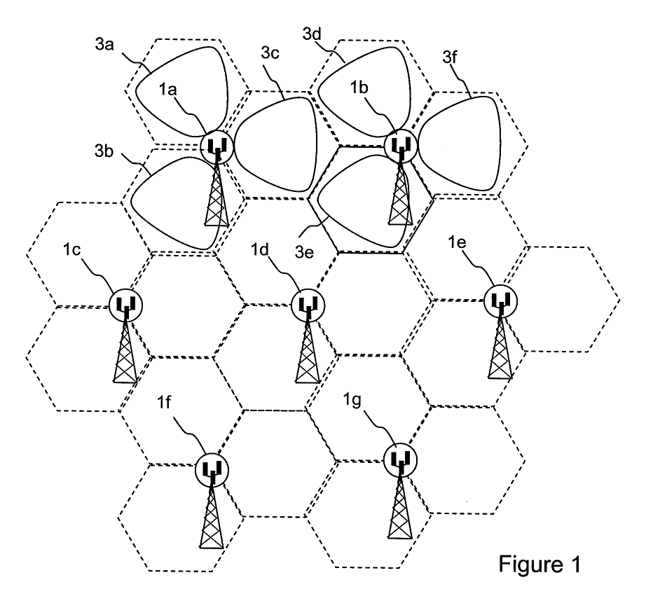

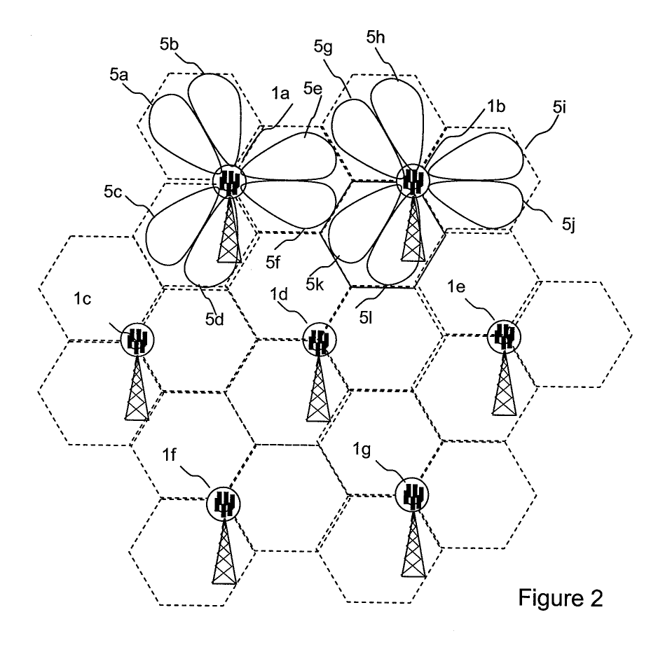

### DETAILED DESCRIPTION OF THE INVENTION

In general, the present invention is directed to methods and apparatus that enhance the capacity of wireless communications between a base station and remote stations by the implementation of space division multiplexing. The invention will be described in the context of a cellular wireless system, but it is to be understood that this example is chosen for illustration only and that other applications of the invention are possible.

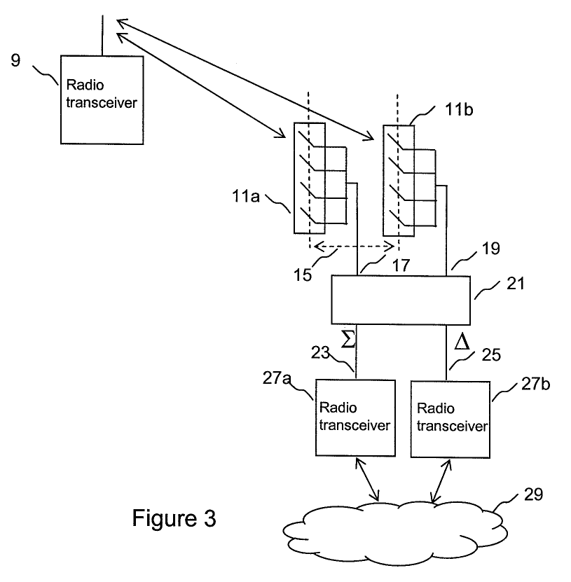

FIG. 3 illustrates a first embodiment of the invention, which relates to space division multiplexing. In the first embodiment, two antennas 11a, 11b and a hybrid combiner 21 produce two antenna beams with different radiation patterns that are connected to respective radio transceivers 27a, 27b. The beam that is produced at the sum port 23 of the hybrid combiner 21 will be referred to as the sum beam, and the beam that is produced at the difference port 25 of the hybrid combiner 21 will be referred to as the difference beam. The radiation patterns of the sum and difference beams in the azimuth plane are dependent on the spacing 15 in azimuth between the antenna systems 11a, 11b. If a radio transceiver 9, typically a mobile user equipment terminal, is situated in a region where the sum beam has more gain than the difference beam, then a connection can typically be established between the radio transceiver 9 and the base station radio transceiver indicated by reference numeral 27b. However, if a radio transceiver 9 is situated in a region where the difference beam has more gain than the sum beam has, then a connection can typically be established between the radio transceiver 9 and the base station radio transceiver indicated by reference numeral 27a.

It can be seen that space division multiplexing is implemented via establishing paths between radio transceivers 9 situated within the coverage area of each beam and the respective base station transceiver 27a, 27b. These paths re-use radio resource blocks; that is to say the frequencies and timeslots used by a radio transceiver 9 served by one beam may coincide with those used by another radio transceiver (not shown) served by the other beam.

Antennas 11a, 11b may be conventional tri-cellular sector antennas. Such antennas typically have a 65 degree beamwidth between points 3 decibels below the peak, and a 120 degree beamwidth between points 10 decibels below the peak.

The sum and difference hybrid combiner 21 can be a bi-directional passive device, allowing transmitted and received signals to pass. In the arrangement shown in FIG. 3, the sum and difference hybrid combiner 21 has the properties that the vector sum of signals on the ports indicated by reference numerals 17 and 19 appears at the sum port 23, and the vector difference between the signals on the ports indicated by reference numerals 17 and 19 appears at the difference port 25. The sum and difference hybrid combiner 21 also has the properties that a signal transmitted into the sum port 23 will be split into in-phase components at the terminals represented by reference numerals 17 and 19, and a signal transmitted into the difference port 25 will be split into anti-phase components at the terminals represented by reference numerals 17 and 19.

The sum and difference hybrid combiner 21 is typically located proximate to the antennas 11a, 11b due to the need to match the cables between the antenna and the sum and difference hybrid combiner in terms of transmission phase; this becomes more difficult and costly, the longer the cable. Whilst, as described above, it may be undesirable to locate active beamforming devices at the top of an antenna tower (due to the difficulty of repair and maintenance), as the sum and difference hybrid combiner is a passive device, no such constraints apply to the positioning of the combiner 21.

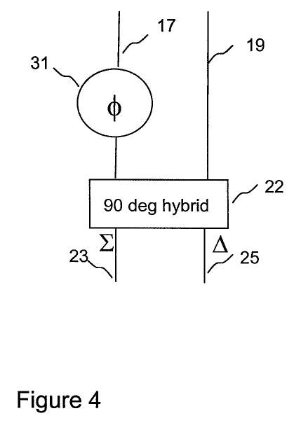

FIG. 4 illustrates an alternative embodiment of sum and difference hybrid combiner 21. In this case, a ninety degree hybrid combiner 22 is used in combination with a phase shifter 31. If the phase shifter is set to ninety degrees, then the circuit illustrated in FIG. 4 will operate as a sum and difference hybrid component, per the embodiment illustrated in FIG. 3. The arrangement shown in FIG. 4 has the benefit that it can be readily implemented using printed coupler technology, which is relatively low cost, and can be deployed within the antenna structure.

The phase shifter 31 may simply be embodied as an adjustable length of transmission line, adjustment of which allows the antenna beams to be steered in azimuth. For example, the phase shifter could be motor driven to allow remote control of the direction of the antenna beams.

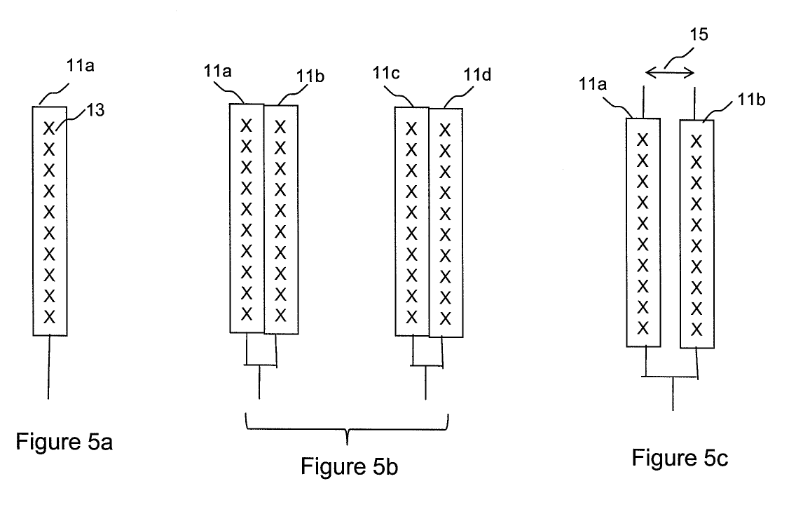

FIGS. 5a, 5b show conventional antenna arrays which can be compared with an antenna array according to an embodiment of the invention, shown in FIG. 5c, in order to illustrate a benefit of an embodiment of the invention. FIG. 5a illustrates a typical tri-cellular array antenna 1 a, comprising a vertical array of antenna elements 13. FIG. 5b illustrates an example of the antenna structures 11a, 11b, 11c, 11d that may be required in a hex-sectored scheme to give coverage to approximately the same angular sector as is given coverage by the tri-cellular antenna shown in FIG. 5a. It can be seen that the antennas structures 11a, 11b and 11c, 11d are typically wider than the tri-cellular antenna, and there will be two antennas in place of one. Alternatively, an antenna for a hex-sectored scheme may comprise a single column of elements with some reflecting structure that cooperates with the antenna so as to increase the effective antenna width (and therefore narrow the beamwidth of the antenna); such an antenna would be wider than a typical tri-cellular antenna, and there will also be a requirement for two antennas in place of one per sector. FIG. 5c illustrates the antenna structure according to an embodiment of the invention that is deployed to provide coverage to the same angular sector as is given by the tri-cellular antenna 11a and by the hex-sectored antenna structure 11a, 11b and 11c, 11d. The antenna structure 11a, 11b shown in FIG. 5c provides two antenna beams within the angular sector, and each beam can have several lobes. The spacing 15 between antenna arrays 11a, 11b will affect the apparent surface area of the antenna structure; in order to reduce wind loading on antenna towers, it is advantageous to minimise the spacing 15. In comparison to the hex-sectored antennas antenna structure shown in FIG. 5b, it can be seen that the antenna area according to embodiments of the invention is smaller.

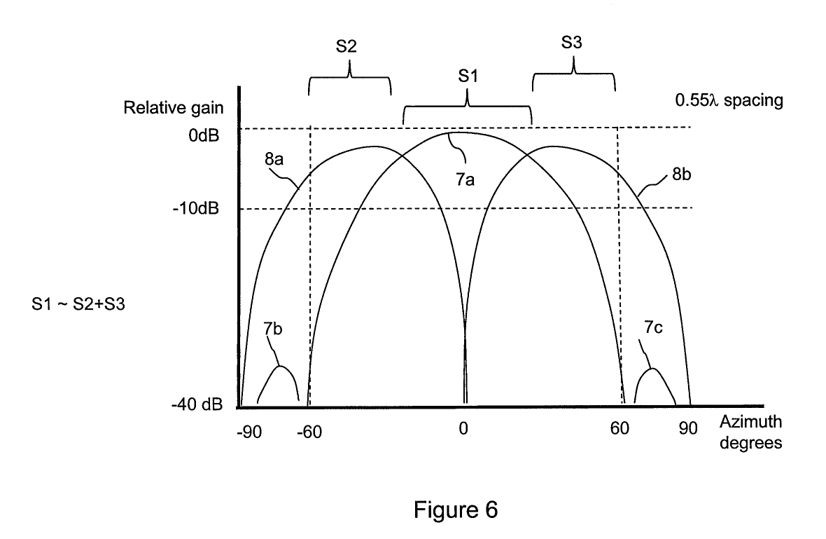

FIG. 6 shows typical sum radiation patterns 7a, 7b, 7c and difference radiation patterns 8a, 8b generated according to an embodiment of the invention in which the spacing 15 between the antenna arrays is 0.55 λ, where λ is the wavelength of signals typically transmitted and received by the antenna structure 11a, 11b. Within a 120 degree sector centred on the sum main beam 7a, it can be seen that the angular sector S1 within which the sum beam 7a is greater than the difference beams 8a, 8b is approximately equal to the total of the angular sectors S2, S3 in which the difference beams 8a, 8b are greater than the sum beam 7a. This indicates that the traffic load balance is approximately one-to-one; that is to say that the two beams would expect to receive approximately equal traffic loading. A one-to-one traffic balance is preferred, since this tends to equalise loading between base station transceivers, where the sum beam is connected to one transceiver and the difference beam is connected to another so as to provide an efficient use of radio resources at a base station.

As has been mentioned, the average carrier to interference ratio can be used to determine the channel data rate that can be sustained, and it thus relates to overall system capacity. It has been established by simulation that ideally an antenna radiation pattern at the ±60 degree points of a tri-sectored layout, also known as a corner-excited layout, should fall to approximately −10 decibels so as to maximise the average carrier to interference ratio. From FIG. 6 it can be seen that with a 0.55 λ antenna array spacing, the difference beam is wider than the ideal value (the −10 decibel points on the difference beam 8a, 8b fall outside of the region representative of a 120 degrees sector). Consequently, the average carrier to interference ratio may not be optimised in this arrangement.

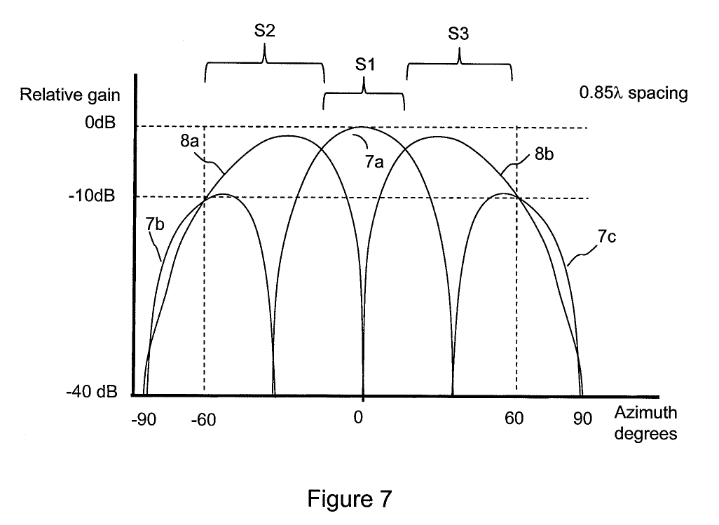

FIG. 7 shows typical sum 7a, 7b, 7c and difference 8a, 8b radiation patterns generated by an embodiment of the invention in which the spacing 15 between the antenna arrays is 0.85 λ. Within a 120 degree sector centred on the sum main beam 7a, it can be seen that the angular sector SI within which the sum beam 7a is greater than the difference beam 8a, 8b is approximately one third of the total of the angular sectors S2, S3 in which the difference beam 8a, 8b is greater than the sum beam 7a. This indicates that the traffic load balance is approximately 3:2, which deviates somewhat from the ideal value of one-to-one. However, the −10 decibel points on the difference beam 8a, 8b are close to the idea value of 120 degrees. It would be expected, therefore, that the contribution to the average carrier to interference ratio due to the effects of overlap between cells may be close to optimum.

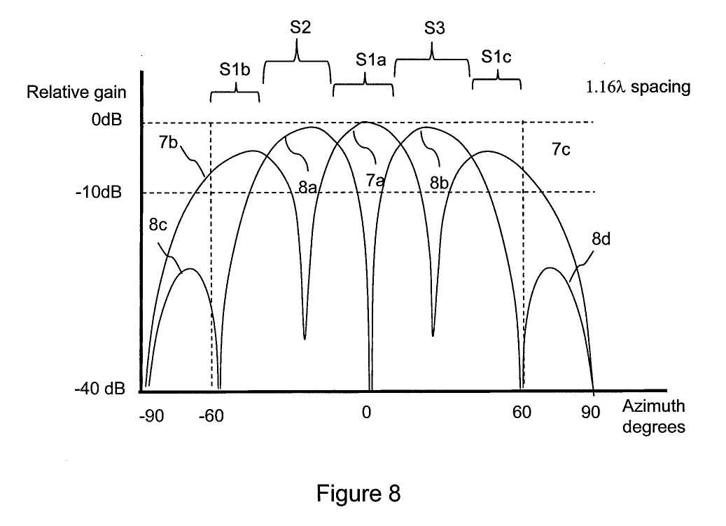

FIG. 8 shows typical sum 7a, 7b, 7c and difference 8a, 8b, 8c, 8d radiation patterns generated by an embodiment of the invention in which the spacing 15 between the antenna arrays is 1.16 λ. Within a 120 degree sector centred on the sum main beam 7a, it can be seen that the angular sector S1a, S1b, S1c within which the sum beam 7a, 7b, 7c is greater than the difference beam 8a, 8b is approximately equal to the total of the angular sectors S2, S3 in which the difference beam 8a, 8b is greater than the sum beam 7a. This indicates that the traffic load balance is approximately one-to-one; that is to say that the two beams would expect to receive approximately equal traffic loading. However, it can be seen that the gain of the sidelobes of the sum beam 7b, 7c are somewhat above the ideal value of −10 decibel at the edges of the ±60 degree sector, that is to say the average carrier to interference ratio may be degraded due to excessive overlap between sectors.

It can thus be seen that there is a trade off between traffic balance and average carrier to interference ratio in the choice of the spacing 15 between antenna arrays in azimuth. If traffic balance is viewed as of primary importance to the wireless network design then candidates for spacing values are those shown in FIGS. 6 and 8, namely 0.55 λ and 1.16 λ. Of these two candidates, and because wider spacings produce multiple pattern lobes 8a, 8b, 7a, 7b, 7c which will lead to more frequent handovers for a user equipment terminal moving through the sector, a spacing of 0.55 λ would be preferred. In addition a more narrowly spaced antenna array has a reduction in apparent surface area, which advantageously reduces wind loading, as has already been mentioned. The dependence of wind loading on spacing is less pronounced when the the spacing exceeds a predetermined amount, after which the apparent surface area will become independent of the spacing 15 and the two antenna arrays can be mounted in two separate radome enclosures.

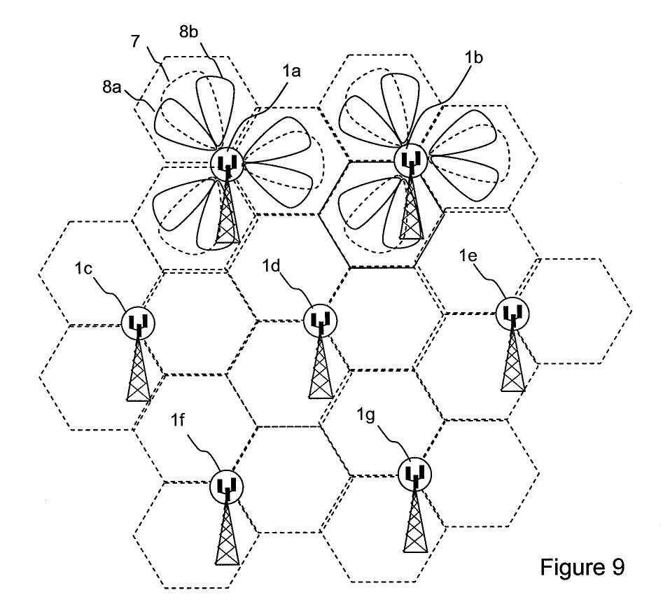

FIG. 9 shows a deployment of an embodiment of the invention with a number of cell sites 1a . . . 1g deployed in typical a cellular arrangement, showing the arrangement of sum 7 and difference 8a, 8b beams. It can be seen that six distinct beams are formed per cell site: three single lobed sum beams and three double lobed difference beams.

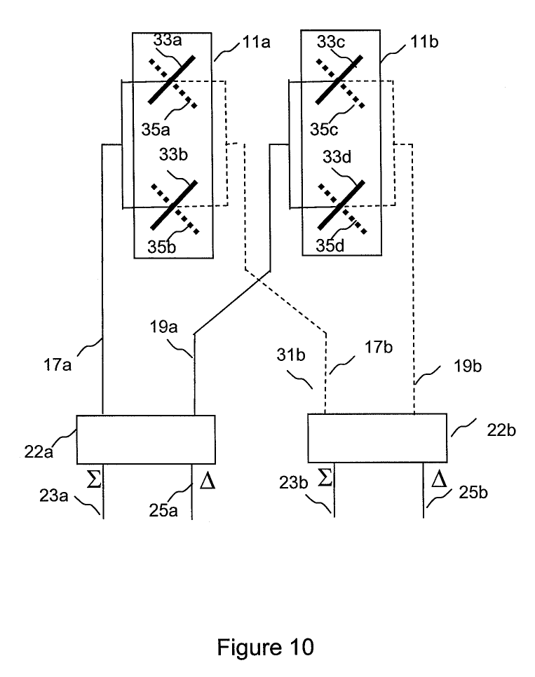

FIG. 10 shows an embodiment of the invention that is arranged to transceive on orthogonal polarisations so as to provide polarisation diversity. An antenna array 11a, comprises antenna elements 33a, 33b that are sensitive to signals of a first state of polarisation and elements 35a, 35b that are sensitive to signals of a state of polarisation orthogonal to the first state of polarisation. Similarly, an antenna array 11b, comprises antenna elements 33c, 33d that are sensitive to signals of a first state of polarisation and elements 35c, 35d that are sensitive to signals of a state of polarisation orthogonal to the first state of polarisation. Antenna elements indicated by reference numerals 33a and 33b are connected to a first hybrid combiner 22a and antenna elements indicated by reference numerals 35a and 35b are connected to a second hybrid combiner 22b. Similarly, antenna elements indicated by reference numerals 33c and 33d are connected to the first hybrid combiner 22a and those indicated by reference numerals 35c and 35d are connected to the second hybrid combiner 22b.

A first hybrid combiner 22a thus has a connection 23a corresponding to a sum beam at a first state of polarisation and a connection 25a corresponding to a difference beam also at the first state of polarisation. Similarly, a second hybrid combiner 22b has a connection 23b corresponding to a sum beam at a first state of polarisation and a connection 25b corresponding to a difference beam also at the first state of polarisation. The connections corresponding to two orthogonal states of polarisation of a beam may be used conventionally to provide polarisation diversity, so that the polarisation carrying the signal of highest quality is used for communication. Alternatively, the connections corresponding to two orthogonal states of polarisation of a beam may be used in a Multiple In Multiple Out system to provide additional signal capacity.

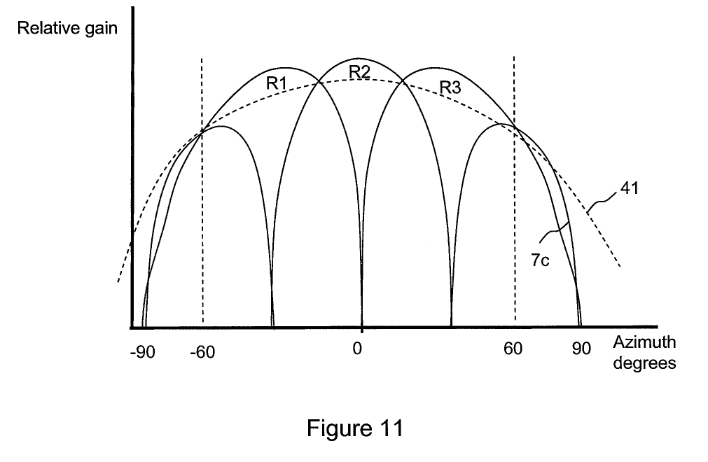

Whilst the above embodiment relates to space division multiplexing, it will be appreciated that embodiments of the invention can also apply to other schemes, for example as a means of selecting a beam having the greater antenna gain and/or directivity. FIG. 11 shows differences between output associated with a conventional tri-cellular antenna beam and that achievable by embodiments of the invention. It can be seen that regions R1, R2, R3 represent improved antenna gain over a conventional tri-cellular antenna; this may be exploited to increase the area coverage of a cell or to reduce the transmit power levels required to maintain a link. In addition, the sum and difference beams according to embodiments of the invention have better directivity, that is, a faster roll-off of gain at the boundaries between 120 degree sectors, than is achievable with a tri-cellular antenna beam. As a result, interference between sectors is potentially reduced, thereby providing a higher average carrier to interference ratio and potentially increasing the capacity of a base station by allowing more radio resource to be used.

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of transceiving radio signals in a wireless communication system, the method comprising:
generating a first radio signal at a first transmitter;
generating a second radio signal at a second transmitter;
combining the first radio signal with the second radio signal to form a first antenna signal and a second antenna signal, each said first antenna and second antenna signals comprising components of the first radio signal and the second radio signal, wherein the component of the first radio signal in the first antenna signal is in a first phase relationship with the component of the first radio signal in the second antenna signal and wherein the component of the second radio signal in the first antenna signal is in a second phase relationship with the component of the second radio signal in the second antenna signal;
transmitting said first antenna signal from a first antenna and transmitting said second antenna signal from a second antenna; and
receiving the transmitted first antenna signal and the transmitted second antenna signal at respective first and second receivers, wherein the first receiver is located in an area within which the components of the first signal in said first and second antenna signals constructively interfere and the components of said second signal in the first and second antenna signals destructively interfere, and wherein the second receiver is located in an area within which the components of the first signal in said first and second antenna signals destructively interfere and the components of said second signal in the first and second antenna signals constructively interfere, whereby to synchronise receipt of signals transmitted from said first transmitter with receipt of signals transmitted from said first transmitter.

2. A method according to claim 1, in which the first and second receivers are positioned such that the first receiver receives the first radio signals at the same time as the second receiver receives the second radio signals.

3. A method according to claim 1 in which each said first and second antennas transmits said first and second antenna signals over a respective coverage area, and at least parts of the respective areas of coverage overlap.

4. A method according to claim 1, including generating said first and second radio signals in the same frequency band.

5. A method according to claim 1, in which the first and second radio signals are transmitted in a space division multiplexed wireless communications system.

6. A system for transceiving radio signals in a wireless communication system, the wireless communication system comprising a first transmitter, a second transmitter, a sum and difference hybrid combiner, and a first antenna and a second antenna, each said antenna being connected to an output of the sum and difference hybrid combiner and being arranged to transmit signals to first and second receivers, wherein the hybrid combiner is arranged to receive input signals from the first and second transmitters at respective inputs thereof so that the first transmitter connected to a first input of the hybrid combiner causes an antenna beam to be transmitted towards the first receiver and the second transmitter connected to a second input of the hybrid combiner causes a further antenna beam to be transmitted towards the second receiver.

7. A system according to claim 6, wherein the first and second antennas are spaced in the azimuth plane by a distance equivalent to between 0.4 and 1.7 wavelengths at the carrier frequency of the signals transmitted to said first and second receivers.

8. A system according to claim 7, wherein the first and second antennas are spaced in the azimuth plane by a distance equivalent to between 0.5 and 1.5 wavelengths at the carrier frequency of the signals transmitted to said first and second receivers.

9. A system according to claim 7 wherein the first and second antennas are spaced in the azimuth plane by a distance equivalent to between 0.5 and 0.6 wavelengths at the carrier frequency of the signals transmitted to said first and second receivers.

10. A system according to claim 7 wherein the first and second antennas are spaced in the azimuth plane by a distance equivalent to between 0.8 and 0.9 wavelengths at the carrier frequency of the signals transmitted to said first and second receivers.

11. A system according to claim 7 wherein the first and second antennas are spaced in the azimuth plane by a distance equivalent to between 1.1 and 1.2 wavelengths at the carrier frequency of the signals transmitted to said first and second receivers.

12. A system according to claim 7, wherein said first and second antennas are adapted to transceive on orthogonal polarisations such that the antenna beam is of a first polarisation and the further antenna beam is of a further polarisation, different to said first polarisation.

13. A method of transceiving radio signals in a wireless communication system, the method comprising:
generating a first radio signal at a first transmitter;
generating a second radio signal at a second transmitter;
combining the first radio signal with the second radio signal to form a first antenna signal and a second antenna signal, each said first antenna and second antenna signals comprising components of the first radio signal and the second radio signal, wherein the component of the first radio signal in the first antenna signal is in a first phase relationship with the component of the first radio signal in the second antenna signal and wherein the component of the second radio signal in the first antenna signal is in a second phase relationship with the component of the second radio signal in the second antenna signal;
transmitting said first antenna signal from a first antenna and transmitting said second antenna signal from a second antenna;
receiving the transmitted first antenna signal and the transmitted second antenna signal at a receiver; and
selecting, for decoding at the receiver, one of the first or second radio signals in dependence on whether the components of the first radio signal in said first and second antenna signals constructively interfere or the components of the second radio signal in said first and second antenna signals constructively interfere.

14. A method according to claim 13, further comprising selecting, for decoding at a further receiver, whichever of the first and second signals is not selected for decoding by the receiver.
